(19) United States
(12) Patent Application Publication
(10) Pub. No.: US 2025/0258078 A1
(43) Pub. Date: Aug. 14, 2025

(54) Air Quality Monitoring Device

(71) Applicant: GONGGAM SENSORS CO., LTD., Daejeon (KR)

(72) Inventors: Myunghee SON, Daejeon (KR); Sung Hoon BAEK, Daejeon (KR)

(73) Assignee: GONGGAM SENSORS CO., LTD., Daejeon (KR)

(21) Appl. No.: 18/797,757

(22) Filed: Aug. 8, 2024

(30) Foreign Application Priority Data
Feb. 14, 2024 (KR) 10-2024-0020893

(51) Int. Cl. G01N 15/0205; F24F 11/00; F24F 110/64; G01N 15/075

(52) U.S. Cl. CPC G01N 15/0205; F24F 11/0001; G01N 15/075; F24F 2110/64

(57) ABSTRACT

This invention relates to an air quality measurement device, featuring a casing with a main inlet duct formed in a straight line and of a predetermined length or longer to allow air to flow from an inlet at the bottom to the top; a flow meter located at the top of the main inlet duct to measure the airflow rate; a laser module that irradiates a laser beam onto the air flowing along the main inlet duct; a light sensor that measures the amount of light scattered by dust particles contained in the air; and a processor that receives the measured values from the light sensor, performs continuous high-speed sampling, estimates the speed of dust particles based on the changes in light intensity, and uses the speed of particles to derive their mass.

### CROSS-REFERENCE TO RELATED APPLICATION

The present application claims priority to Korean Patent Application No. 10-2024-0020893, filed Feb. 14, 2024 and the entire contents of which are incorporated herein by reference.

### TECHNICAL FIELD

The present invention relates to an air quality monitoring device. It concerns a device capable of measuring dust contained in the air to assess air quality.

### BACKGROUND ART

Typically, light-scattering particulate matter monitoring devices are employed to measure the concentration of particulate matter, such as fine dust, in the air. These devices operate by illuminating light and detecting the scattered light to determine the concentration of particulate matter.

FIG. 1 schematically shows the configuration of a conventional particulate matter monitoring device. As depicted, in the conventional particulate matter monitoring device, the air A enters an inlet 11a at the top and the measured air A1 is discharged through an outlet 11b at the bottom.

An air heating device 13, an air quality measurement sensor 14, a flow meter 15, and a high-power air pump 16 are sequentially positioned along the path where the air A moves vertically from top to bottom.

The conventional particulate matter monitoring device introduces the air A at a constant flow rate into the inlet 11a using a high-power air pump 16, whereupon the air quality measurement sensor 14 measures the concentration of particulate matter. Before measurement by the air quality measurement sensor 14, the air heating device 13 increases the temperature of air A to decrease the relative humidity of air, thereby dehumidifying the hygroscopic particulate matter.

However, heating air A with the air heating device 13 raises the air's temperature, thereby generating buoyancy in the opposite direction of the airflow. A high-power air pump 16 is necessitated to enable air to flow against this buoyancy that is opposite to the direction of the airflow. Both the high-power air pump 16 and this buoyancy having the reverse direction against airflow significantly decrease the internal air pressure within the air passage, thereby leading to a significant expansion of air volume. This expansion of air volume can cause measurement errors for particulate matter.

The air heating device 13 generates heat, which in turn creates buoyancy and alters the airflow. However, devices that measure atmospheric pollutants such as fine dust require a steady airflow.

Furthermore, according to Bernoulli's principle, the air pressure inside the air passage decreases in proportion to the height of the passage, generating air energy upward in the opposite direction of the airflow. To compensate for this, the high-power air pump 16 requires additional power.

Moreover, the traditional methods that allow the air to flow vertically from top to bottom cause heavier dust particles to deposit on the inside of the casing 11, thus regular cleaning is required.

Additionally, traditional light-scattering measurement devices cannot measure the mass of dust particles. They deterministically infer the density of particles and convert it to mass for concentration measurement. This method is prone to error for particulate matter such as yellow dust that has a notably high density.

### DISCLOSURE

### Technical Problem

The present invention introduces an air quality monitoring device that can more accurately measure the concentration of dust in the atmosphere. By illuminating air vertically flowing up from the bottom and detecting the scattered light by dust particles, this invention calculates the speed of each dust particle using the duration of light-scattering. The mass of each dust particle can be determined from the speed so this invention enables a more precise measurement of atmospheric dust concentration. This invention can measure the mass of yellow dust particles and general dust particles that have different density, thereby enabling a more accurate measurement of particulate matter concentration based on mass.

### Technical Solution

According to an embodiment of the present invention, the air quality monitoring device comprises a casing with a main inlet duct formed in a straight line of a predetermined length or longer to allow atmospheric air to enter an inlet at the bottom and flow upwards; a flow meter provided at the top of the main inlet duct to measure the flow rate of the air; a laser module that emits a laser beam into the air flowing in the main inlet duct; a light sensor that measures the amount of light scattered by dust particles contained in the air; and a processor that receives measured values from the light sensor, performs continuous high-speed sampling, measures the speed of dust particles from the changes of light intensity, and derives their mass using their speed.

Additionally, the casing includes a secondary inlet duct that allows more air to be introduced from a secondary inlet placed at its bottom. The top of the secondary inlet duct is connected to the top of the main inlet duct to allow its air to be merged with the air that entered the main inlet duct.

Moreover, it includes a common inlet duct that is formed to allow air to be introduced from a common inlet at its bottom and a secondary inlet duct that is connected to both the top of the common inlet duct at its bottom and the top of the main inlet duct at its top. A portion of the air that flows out from the common inlet duct branches and flows into the main inlet duct, while the remaining portion of the air flows into the secondary inlet duct and is merged with the air flowing out from the top of the main inlet duct.

Furthermore, the cross-sectional area of the secondary inlet duct is formed to be larger than that of the main inlet duct.

The laser module includes a laser source that generates a laser beam, a lens that changes the shape and direction of the laser beam generated by the laser source, and a laser capture that confines the laser beam after the laser beam passes through the main inlet duct.

The focus depth of the laser beam emitted by the laser module is formed to be equal to or greater than the width of the main inlet duct.

Additionally, the laser module includes a rectangular laser beam shaper that changes the cross-sectional shape of the laser beam generated by the laser source into a rectangle.

The casing further includes an outlet duct formed at the bottom to allow air that passes through the main inlet duct to be discharged and a direction-changing duct that connects the top of the main inlet duct and the top of the outlet duct to change the direction of airflow.

The inlet and outlet are placed at the same height.

The device further includes an air ventilation device provided inside the casing, which creates negative air pressure to allow air to flow from the inlet to the outlet.

Moreover, the cross-sectional area of the common inlet duct is formed to be equal to or larger than the sum of the cross-sectional areas of the main inlet duct and that of the secondary inlet duct to ensure that the speed of dust particles in the main inlet duct is above a predetermined minimum speed.

Details of other embodiments are included in the detailed description and drawings.

### Advantageous Effect

The air quality monitoring device according to this invention offers the following benefits:

By irradiating a laser beam into the air and measuring each speed of dust particles contained in the air using the intensity and duration of the scattered light when a dust particle scatters the laser beam, it is possible to calculate the mass of each dust particle. Consequently, this provides the advantage of being able to determine the concentration of fine or coarse dust particles more accurately than existing real-time fine dust monitoring devices that lack information on the mass of dust particles.

### DESCRIPTION OF DRAWINGS

FIG. 1 is a schematic diagram showing a conventional particulate matter monitoring device.

FIG. 2 is a schematic diagram showing an air quality monitoring device according to an embodiment of the present invention.

FIG. 3 is a schematic diagram showing an air quality monitoring device according to another embodiment of the present invention.

FIG. 4 is an enlarged perspective view of the light sensor and laser beam section corresponding to part ‘B’ of FIG. 2.

FIG. 5a is a conceptual diagram of a dust particle passing through a laser beam in the air. FIG. 5b is a graph showing the intensity of scattered light emitted while a dust particle passes through the laser beam over time.

FIG. 6 is an enlarged perspective view showing some of the parts around the inlet duct of an air quality monitoring device without a physical wall between the main inlet duct and the secondary inlet duct according to another embodiment of the present invention.

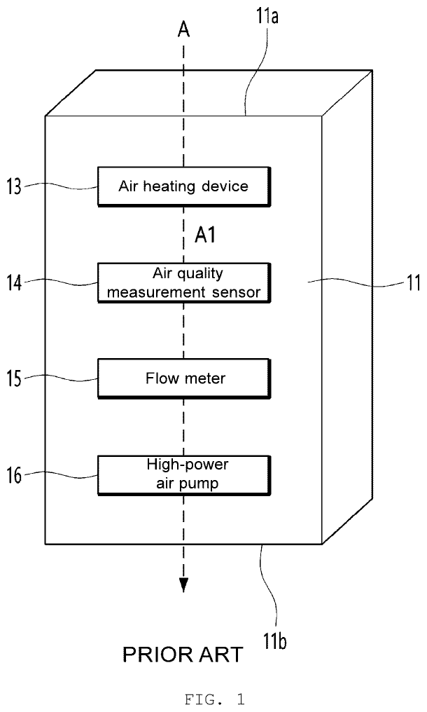

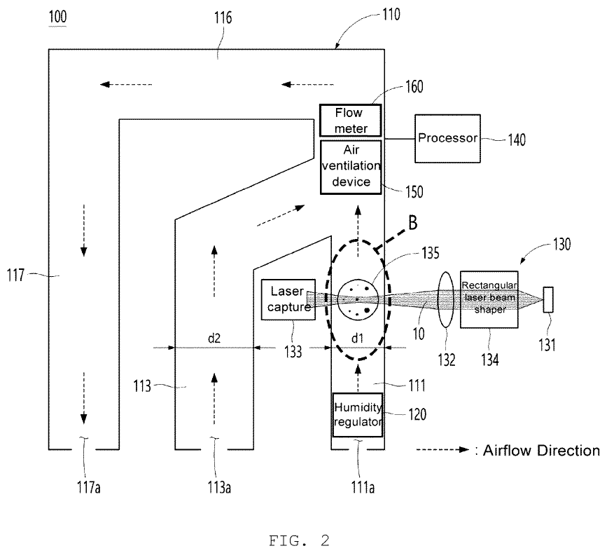

### DESCRIPTION OF REFERENCE NUMERALS

1: Dust particle
10: Laser beam
100, 100′: Air quality monitoring device
110, 110′: Casing
111, 111′: Main inlet duct
111a: Inlet
113, 113′: Secondary inlet duct
113a: Secondary inlet
114: Common inlet duct
114a: Common inlet
116: Direction-changing duct
117: Outlet duct
117a: Outlet
120: Humidity regulator
130: Laser module
131: Laser source
132: Lens
133: Laser capture
134: Rectangular laser beam shaper
135: Light sensor
135a: Measurement surface of the light sensor
140: Processor
150: Air ventilation device
160: Flow meter

### MODE FOR INVENTION

Hereinafter, with reference to the accompanying drawings, embodiments of the present invention are described in detail so that those skilled in the art to which this invention pertains can easily implement the invention. It is understood that the invention can be implemented in various different forms and is not limited to the embodiments described herein.

It is noted that the drawings are schematic and not necessarily drawn to scale. The relative dimensions and proportions of parts in the drawings have been exaggerated or minimized for clarity and convenience and should not be considered limiting. Arbitrary dimensions are illustrative and not restrictive. Identical reference numerals are used in two or more drawings to denote similar structural elements or parts for the purpose of indicating similar features.

The embodiments of the present invention specifically illustrate ideal embodiments of the invention, and as a result, various modifications in the drawings are anticipated. Therefore, the embodiments are not limited to the specific forms shown and include, for example, variations due to manufacturing.

The objective of the present invention is to measure the mass of each dust particle, such as fine dust or coarse dust in the atmosphere, to measure the concentration of fine dust or coarse dust more accurately. The air quality monitoring device according to the present invention measures the mass of each dust particle. Since dust particles in the air experience gravitational force downward and air resistance force upward, each dust particle has a different speed depending on its weight and size, from which its mass is calculated by measuring its speed.

The air quality monitoring device according to the present invention includes a structure capable of creating a sophisticated constant slow airflow to improve the precision of measurement regardless of external interference.

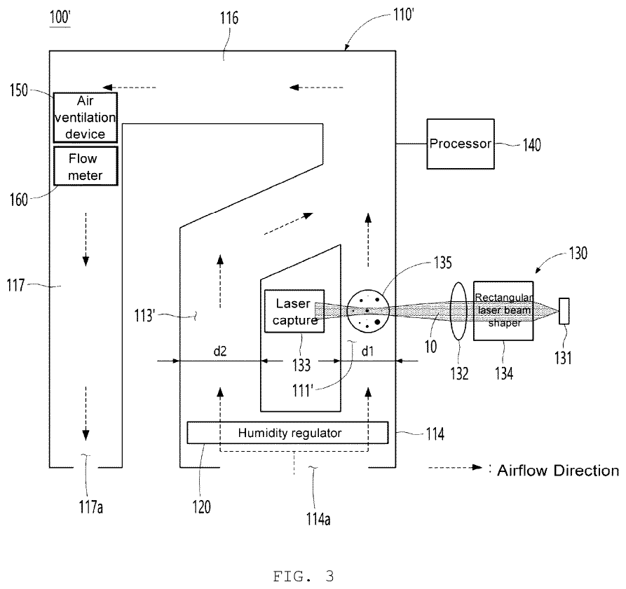

Referring to FIGS. 2 to 5, the air quality monitoring device according to the present invention is described in detail.

Firstly, the air quality monitoring device 100 according to an embodiment of the present invention includes a casing 110, a flow meter 160, a laser module 130, a light sensor 135, and a processor 140.

The casing 110 includes an inlet 111a formed at the bottom and has a main inlet duct 111 formed in a straight line of a length that is equal to or longer than a predetermined length. Atmospheric air flows into the inside of the main inlet duct 111 through the inlet 111a. The air introduced into the main inlet duct 111 flows vertically upwards along the main inlet duct 111. Thus, dust particles in the air experience gravitational force downward and air resistance force upward, and each particle can have a different speed based on its weight and size.

As mentioned, by having the main inlet duct 111 formed in a straight line and with a length that is a predetermined length or longer, the main inlet duct 111 allows the air to flow in a straight direction at a constant speed.

The casing 110 further includes a secondary inlet duct 113. In this invention, the secondary inlet duct is provided in two exemplary forms, as shown in FIGS. 2 and 3.

First, FIG. 2 shows the secondary inlet duct that is provided according to one embodiment. In this embodiment, the secondary inlet duct 113 is a predetermined distance away from the main inlet duct 111 and has a separate air passage. The secondary inlet duct 113 has a secondary inlet 113a at the bottom. The top of the secondary inlet duct 113 is connected to the top of the main inlet duct 111 so that the air of the main inlet duct 111 can be merged with the air of the secondary inlet duct 113.

The secondary inlet duct 113 is formed with a secondary inlet 113a at the bottom. Air introduced from the secondary inlet 113a flows in the secondary inlet duct 113.

The air introduced into the casing 110 always flows at a constant flow rate. However, as in this embodiment, when the air at a constant flow rate is divided between the main inlet duct 111 and the secondary inlet duct 113, the airflow speed slows down compared to the case when air enters only the main inlet duct 111. Thus, the secondary inlet duct 113 serves to reduce the airflow speed flowing in the main inlet duct 111.

Especially, the cross-sectional area d2 of the secondary inlet duct 113 can be formed to be larger than the cross-sectional area d1 of the main inlet duct 111. Therefore, the flow rate in the secondary inlet duct 113 is greater than that in the main inlet duct 111, and the airflow speed flowing in the main inlet duct 111 can be further reduced.

Slowing down the airflow speed flowing in the main inlet duct 111 enhances the resolution of dust particle speed that is processed by the processor 140 with the light sensor 135, thus dust particle speeds can be more accurately measured.

In this way, each dust particle in the main inlet duct 111 experiences gravitational force downwards and air resistance force upwards due to the air flowing upwards. Within the main inlet duct 111, which has a length that is predetermined or longer and is formed in a straight line, an equilibrium is established for each dust particle when the air resistance force becomes equal to the gravitational force. At this point, each dust particle flows at its stable speed. Since each particle has different gravitational force and air resistance, the speed of each particle is different.

The air resistance force is determined by the particle size and the difference between the airflow speed and the dust particle speed, while the gravitational force is determined by the mass of the particle. In the equilibrium, the air resistance force is equal to the gravitational force in magnitude and opposite to the gravitational force in direction. By measuring the size and speed of particles using light-scattering technology and maintaining a constant airflow speed, the mass of each dust particle can be determined.

FIG. 3 shows the configuration of the secondary inlet duct according to another embodiment. In this variant, the main inlet duct 111′ and the secondary inlet duct 113′ do not have separate inlets. That is, air that is introduced into a common inlet 114a flows into both the main inlet duct 111′ and the secondary inlet duct 113′ after passing through the common inlet duct 114.

When a constant flow rate of air is introduced into the casing 110′, it branches and flows into both the main inlet duct 111′ and the secondary inlet duct 113′, thus the airflow speed decreases in the main inlet duct 111′. Thus, the secondary inlet duct 113′ functions to decrease the speed of airflow in the main inlet duct 111′.

Specifically, the cross-sectional area d2 of the secondary inlet duct 113′ can be made larger than the cross-sectional area d1 of the main inlet duct 111′. Therefore, if the flow rate of air entering the secondary inlet duct 113′ is greater than that entering the main inlet duct 111′, the airflow speed in the main inlet duct 111′ can be further reduced.

The casing 110 further includes an outlet duct 117 and a direction-changing duct 116. The outlet duct 117 has an outlet 117a at the bottom. The air within the outlet duct 117 flows downward and is discharged externally from the outlet 117a. The outlet 117a, the inlet 111a, the common inlet 114a, and the secondary inlet 113a can all be placed at the same height.

The direction-changing duct 116 is arranged to begin at the intersection of the tops of the main inlet duct 111, 111′ and the secondary inlet duct 113, 113′ and end at the intersection with the top of the outlet duct 117. Namely, one side of the direction-changing duct 116 is connected to both the main inlet duct 111, 111′ and the secondary inlet duct 113, 113′ to make air passage. The other side of the direction-changing duct 116 is connected to the outlet duct 117 to make air passage.

The direction-changing duct 116 is designed to change the direction of air flowing out from the top of the main inlet duct 111, 111′ to point towards the outlet duct 117.

The outlet 117a of the outlet duct 117 is positioned at the same level as the inlet 111a, the common inlet 114a, and the secondary inlet 113a. In essence, the inlet 111a, the common inlet 114a, and the outlet 117a are located on a virtually horizontal plane.

The rationale for aligning the inlet 111a, the common inlet 114a, and the outlet 117a at the same height is the following considerations:

First, the heat generated by the humidity regulator 120 creates buoyancy. If the inlet 111a, common inlet 114a, and outlet 117a have different heights, the buoyancy at the inlet 111a and common inlet 114a differs from that at the outlet 117a, leading to unintended changes in flow rate. Therefore, the heights of the inlet 111a, the common inlet 114a, and the outlet 117a are aligned to prevent such unintended changes of flow rate.

Additionally, according to Bernoulli's principle, the height of a pipe affects the pressure inside it. If the inlet 111a, the common inlet 114a, and the outlet 117a have different heights, the air pressure at these points changes and results in unintended airflows. Hence, the aligned heights of the inlet 111a, the common inlet 114a, and the outlet 117a eliminate unintended airflows.

The main inlet ducts 111, 111′, secondary inlet ducts 113, 113′, and the outlet duct 117 are vertically formed, though slight deviations within a certain error range are acceptable. That is, they extend and generally up down nearly perpendicular to a horizontal plane.

A flow meter 160 is located inside the casing 110. In one embodiment of the invention, as shown in FIG. 2, the flow meter 160 is positioned at the top of the main inlet ducts 111, 111′, while in another embodiment, as shown in FIG. 3, it is located in the outlet duct 117.

Since the ratio of flow rates in the main inlet duct 111, 111′ and the secondary inlet duct 113, 113′ are constant, the flow rate in the main inlet duct 111, 111′ is measurable regardless of where the flow meter 160 is located along the airflow path.

Therefore, the flow meter 160 can also be located at the direction-changing duct 116, the main inlet ducts 111, 111′, the secondary inlet ducts 113, 113′, or the common inlet duct 114.

The air ventilation device 150 generates negative pressure to ensure that air flows through the main inlet ducts 111, 111′ towards the outlet duct 117. The air ventilation device 150 can be located at the top of the main inlet ducts 111, 111′ as shown in FIG. 2 or at the top of the outlet duct 117 as shown in FIG. 3. Additionally, it can be placed anywhere along the airflow path, such as in the main inlet ducts 111, 111′, the secondary inlet ducts 113, 113′, the common inlet duct 114, the direction-changing duct 116, or the outlet duct 117.

The flow meter 160 and air ventilation device 150 aim to maintain the airflow speed in the main inlet duct 111, 111′ at a predetermined rate. Therefore, the processor 140 obtains instant flow rates from the flow meter 160 and adjusts the strength of the air ventilation device 150 depending on the instant flow rate to keep the flow rate at a predetermined value.

The laser module 130 emits a laser beam into the air flowing in the main inlet ducts 111, 111′. The laser module 130 includes a laser source 131, a lens 132, and a laser capture 133. The laser source 131, the lens 132, and the laser capture 133 are positioned to cross the main inlet ducts 111, 111′ perpendicularly as shown in FIGS. 2 and 3, thus dust particles cannot deposit inside the laser module 130.

The laser beam generated by the laser source 131 passes through the lens 132 and irradiates the main inlet ducts 111, 111′. The lens 132 narrows the thickness of the laser beam. The main inlet ducts 111, 111′ are located between the lens 132 and the laser capture 133. After the laser beam passes through the lens 132, it irradiates the main inlet ducts 111, 111′. Then the laser capture 133 confines and removes the laser beam.

The air quality monitoring device 100 according to this invention emits a laser beam into the main inlet ducts 111, 111′, and uses the duration of light scattered by a dust particle contained in the air to calculate the speed of these particles. The accuracy of speed measurement can be improved by a sufficiently long duration of scattered light. In addition, it is required to obtain a constant precise slow airflow speed in the main inlet ducts 111, 111′.

For accurate measurement, the thickness of the laser beam within the main inlet ducts 111, 111′ must remain constant. Therefore, the focus depth of the laser beam emitted by the laser module 130 should be equal to or greater than the width of the main inlet ducts 111, 111′. Specifically, the focus depth of the laser beam can be longer than the width of the main inlet ducts 111, 111′, or the width of the main inlet ducts 111, 111′ can be shorter than the focus depth of the laser beam.

For a laser module 130 with a short focus depth, the width of the main inlet ducts 111, 111′ needs to be narrow, then it increases the airflow speed. Thus, secondary inlet ducts 113, 113′ are required to achieve a finely slow airflow speed.

The typical laser beam generated by the laser source 131 has a circular shape. However, the time it takes for dust particles to pass through the circular cross-section of the laser beam (the duration of scattered light) may differ between the center and the edge of the circle. To prevent this, the laser module 130 can include a rectangular laser beam shaper 134 that transforms the cross-sectional shape of the laser beam into a rectangle. Typically, the rectangular laser beam shaper 134 is placed between the laser source 131 and the lens 132.

With the rectangular laser beam shaper 134, the traveling distance of dust particles passing through the laser beam 10 is always constant, regardless of the distance between the dust particle and the center of the beam.

The light sensor 135 measures the amount of light that the laser beam is scattered by a dust particle contained in the air. The values measured by the light sensor 135 are transmitted to the processor 140.

The light sensor 135 is located inside the casing 110, specifically within the main inlet ducts 111, 111′, near the focal point of the laser beam 10, thus the amount of scattered light can be measured when the laser beam is scattered by a dust particle.

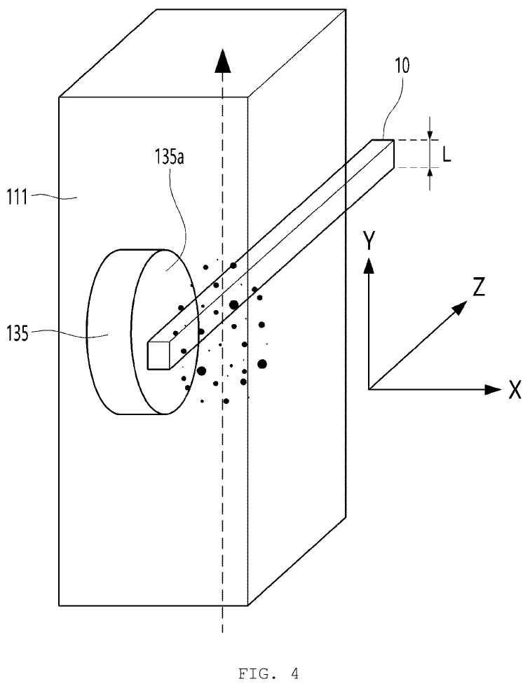

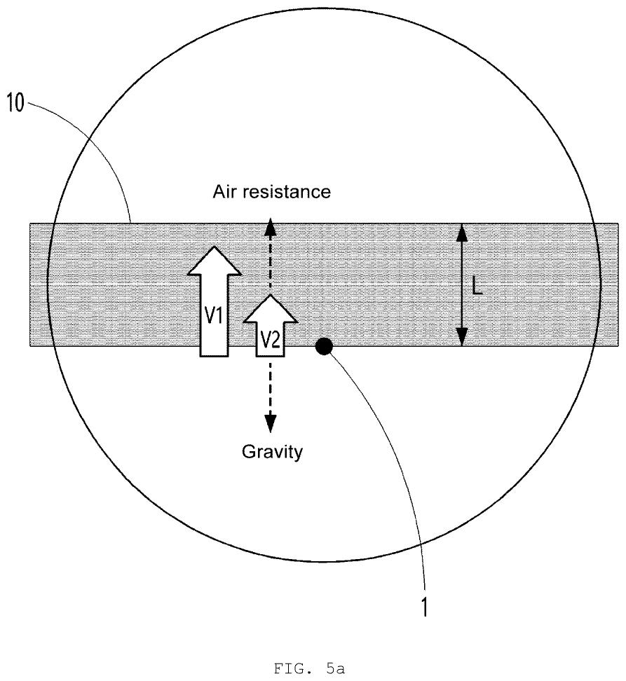

FIG. 4 is an enlarged perspective view of the light sensor 135 and the laser beam 10 at the intersection corresponding to part ‘B’ of FIG. 2. Generally, the sensing surface of the light sensor 135 is three-dimensionally orthogonal to two directions of the laser beam 10 and the airflow. That is, if the airflow direction is the Y-axis (opposite to gravity) and the laser beam direction is the Z-axis, then the measuring surface 135a of the light sensor 135 faces the X-axis.

The processor 140 performs continuous high-speed sampling of the values transmitted by the light sensor 135 and measures the size and speed of each dust particle from the temporal changes in light intensity.

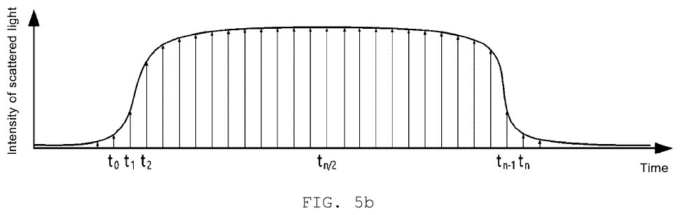

The processor 140 includes an analog-to-digital converter (not shown) to perform continuous high-speed sampling. FIG. 5a illustrates a moment when a dust particle 1 passes through the laser beam 10 irradiated by the laser module 130. As shown in FIG. 5a, the intensity of scattered light changes while the dust particle 1 moves from the lowest to the highest position within the laser beam 10.

The analog-to-digital converter continuously and rapidly samples the output data of the light sensor 135 and stores them in the processor 140's memory in temporal order. These data can be represented as a graph shown in FIG. 5b.

As described above, the processor 140 measures the speed of a dust particle 1 from the changes of light intensity detected by the light sensor 135. Specifically, the speed of a dust particle 1 is measured from the time t0 and the time tn. The time t0 is the time when the intensity of light starts to increase at the lowest position of the laser beam 10. The time tn is the time when the increased intensity of light ends at the highest position of the laser beam 10.

After determining the speed of the dust particle 1, the processor 140 derives the mass or density of the dust particle 1 based on the size of the dust particle 1 and the difference in speed between the air and the dust particle 1. The principle for deriving the mass of each dust particle 1 is as follows:

As the air in the main inlet ducts 111, 111′ flows upwards, a dust particle 1 rises due to air resistance. However, the speed of the dust particle 1 is reduced due to downward gravity. The air resistance depends on the difference in speed between the air and the dust particle 1. In a steady state when each dust particle 1 reaches a constant speed, the air resistance force equals gravitational force.

Using this principle, the mass of each dust particle 1 is given by Equation 1.

$$mg = {c ( {v}_{1} - {v}_{2} )}^{2} π {r}^{2} \qquad [ Equation 1 ]$$

In Equation 1, m represents the mass of a dust particle, g is the Earth's gravitational acceleration, c is a constant derived from the air density and the drag coefficient of a dust particle, v1 is the airflow speed, v2 is the speed of a dust particle, n is the mathematical constant pi, and r is the radius of a dust particle.

The speed of a dust particle, v2, can be calculated using the following Equation 2.

$${v}_{2} = \frac{L}{{t}_{n} - {t}_{0}} \qquad [ Equation 2 ]$$

In Equation 2, tn represents the time when a dust particle is at the highest position in the laser beam area 10. t0 is the time when a dust particle is at the lowest position in the laser beam area 10. L is the thickness of the laser beam 10.

Here, the time when a dust particle is at the lowest position of the laser beam 10 refers to the time at which the intensity of scattered light begins to increase, and the time when a dust particle is at the highest position of the laser beam 10 refers to the time at which the intensity of scattered light begins to decrease. Thus, the values of tn and t0 can be obtained from the graph shown in FIG. 5b.

An analog-to-digital converter (not shown in the drawings) or one integrated within the processor 140 continuously samples the analog output of the light sensor 135 at regular intervals, converting them into digital data which are then sequentially stored in the processor 140's memory or in a separate memory (not shown in the drawings).

At the time t0 when a dust particle encounters the laser beam 10, the dust particle scatters the beam and the output of the light sensor 135 increases. While the dust particle passes through the laser beam 10, the output of the light sensor 135 remains high. At the time tn when the particle completes passing through, the output of the light sensor 135 decreases. This sampling data can be represented as a graph shown in FIG. 5b.

Furthermore, the processor 140 can also derive the density of a dust particle 1, which can be obtained by Equation 3 driven from Equation 1.

$$ρ = {{c}_{2} ( {v}_{1} - {v}_{2} )}^{2} / r \qquad [ Equation 3 ]$$

In Equation 3, ρ represents the density of a dust particle, and c2 is a constant determined by the air density, the drag coefficient of the dust particle, and the Earth's gravitational acceleration. v1 is the speed of the air in the main inlet duct 111, v2 is the speed of a dust particle, and r is the radius of the dust particle.

The air quality monitoring device 100, 100′ according to this invention also includes a humidity regulator 120 and an air ventilation device 150. The humidity regulator 120 removes moisture contained in the air flowing through the inlet ducts 111, 111′ from the inlets 111a, 114a. Therefore, the humidity regulator 120 is located inside the main inlet duct 111, 111′ or the common inlet duct 114, positioned above the inlets 111a, 114a but below the light sensor 135.

As air passes through the humidity regulator 120, it is heated, and its relative humidity decreases. Although not shown in the drawings, an external temperature and humidity sensor (not shown) can alternatively be installed at the inlets 111a, 114a to measure the air's temperature and relative humidity. This external temperature and humidity sensor sends the measured temperature and relative humidity to the processor 150.

Additionally, the humidity regulator 120 may include an internal temperature and humidity sensor (not shown) to measure the temperature and relative humidity of the heated air, which can be transmitted to the processor 140.

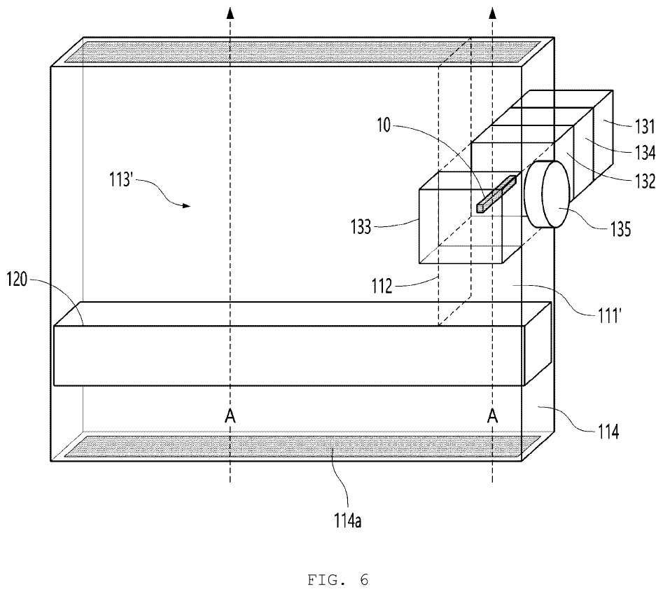

Meanwhile, there can be an absence of physical wall dividing the main inlet duct and the secondary inlet duct. FIG. 6 shows a conceptual example of the air quality monitoring device without a physical wall between the main inlet duct 111′ and the secondary inlet duct 113′.

FIG. 6 is an enlarged perspective view of the inlet duct part of another embodiment depicted in FIG. 3, where the boundary 112 dividing the main inlet duct 111′ and the secondary inlet duct 113′ does not exist as a physical wall. The main inlet duct 111′, secondary inlet duct 113′, and common inlet duct 114 can be created without any wall between them, functionally defined as separate spaces. The common inlet duct 114 draws air from the atmosphere, and the secondary inlet duct 113′ functions to reduce the airflow speed in the main inlet duct 111′ by dividing the air from the common inlet duct 114.

If the speed v2 of a dust particle 1 in the main inlet duct 111′ falls below a predetermined speed, the dust particle 1 can attach to internal components such as the light sensor 135, thereby impairing measurement performance. To solve this problem, the cross-sectional area of the common inlet duct 114 is made larger than the combined cross-sectional areas of the main inlet duct 111′ and the secondary inlet duct 113′. This configuration ensures that the dust particle 1 in the main inlet duct 111′ maintains a speed above the predetermined (minimum) speed. This is because the airflow speed in the common inlet duct 114 is slower than in the main inlet duct 111′. There is no dust particle 1 whose speed is below the predetermined speed in the main inlet duct 111′ because dust particle 1 whose speed will be below the predetermined speed in the main inlet duct 111′ cannot pass through the common inlet duct 114 that has a slow flow rate. The dust particle 1 above the predetermined speed rises and cannot adhere to the inside of the main inlet duct 111′ due to its speed.

FIG. 6 shows a rectangular-shaped laser beam 10. The rectangular laser beam shaper 134 makes the shape of the cross-sectional area of the laser beam 10 in the form of a rectangle or quadrilateral. One side of this rectangle should be parallel to the direction of the air. The cross-section of the laser beam emitted from the laser source 131 forms a circle, while the rectangular laser beam shaper 134 transforms the circular laser beam into a rectangular one. The rectangular laser beam shaper 134 can be implemented using existing beam shaping technologies such as a top hat shaper. The rectangular laser beam emitted from the rectangular laser beam shaper 134 passes through the lens 132, which narrows the thickness of the beam.

The method of creating a rectangular laser beam is not limited to the use of the rectangular laser beam shaper mentioned in this embodiment. Therefore, the rectangular laser beam shaper 134 can be placed elsewhere, and the positions of the rectangular laser beam shaper 134 and the lens 132 are interchangeable.

As described above, the air quality monitoring devices 100, 100′ according to this invention have a structure that controls the air to flow vertically from bottom to up at a precise constant slow speed uninterrupted by external influences. Each dust particle in the air, pulled by gravity in the opposite direction of the airflow, has a different speed depending on its weight and size. The mass of each particle can be obtained by measuring the size and speed of the particle with optical and electronic technologies according to this invention.

The air quality monitoring devices 100, 100′ as described above can calculate the concentration of fine or coarse particulate matter by measuring the number of dust particles, along with the mass and size of each particle. The concentration of fine or coarse particulate matter is defined in terms of mass per unit volume. Therefore, knowing the count, size, and mass (density) allows a for highly accurate measurement of particulate matter concentration.

In contrast to traditional light-scattering measurement devices, which estimated the concentration of particulate matter without measuring the density of particles, leading to inaccuracies. The air quality monitoring device according to this invention can measure the concentration of particulate matter precisely by knowing the count, size, and mass (density).

Furthermore, the measuring device according to this invention can also be applied to measure impurities in water. By substituting air with water and dust particles with waterborne impurities in the detailed description of this invention, it is possible to measure the size, mass, and count of each impurity in the water.

While the embodiments of the invention have been described with reference to the accompanying drawings, it is understood that those skilled in the art may realize the invention can be implemented in other specific forms without departing from the technical spirit or essential features thereof.

Therefore, the described embodiments should be considered in all respects as illustrative and not restrictive. The scope of the invention is indicated by the following claims rather than the foregoing and description, all changes or modifications derived from the meaning and scope of the claims and their equivalents should be interpreted as being included within the scope of the present invention.

What is claimed is:

1. An air quality monitoring device comprising:
A casing with a main inlet duct formed in a straight line of a predetermined length or longer to allow atmospheric air to enter an inlet at the bottom and flow upwards;
A flow meter located at the top of the main inlet duct to measure the flow rate;
A laser module that emits a laser beam into the air flowing in the main inlet duct;
A light sensor that measures the amount of light scattered by a dust particle contained in the air; and
A processor that receives the measured values from the light sensor, performs continuous high-speed sampling, estimates the speed of a dust particle from the changes in light intensity, and derives its mass or density with the speed of the dust particle.

2. The air quality monitoring device of claim 1, wherein the casing further includes a secondary inlet duct, which is connected to the main inlet duct at its top, allows more air to be introduced to a secondary inlet formed at its bottom and merges the air of its top with the air that flows out from the main inlet duct.

3. The air quality monitoring device of claim 1, further includes a common inlet duct formed to allow air to flow into a common inlet at its bottom; and a secondary inlet duct connected to the top of the common inlet duct at its bottom and the top of the main inlet duct at its top, wherein a portion of the air flowing out from the common inlet duct branches and flows into the main inlet duct, while the remaining portion of the air flowing out from the common inlet duct flows into the secondary inlet duct and the air flowing out from the top of the main inlet duct is merged with the air flowing out from the secondary inlet.

4. The air quality monitoring device of claim 2, wherein the cross-sectional area of the secondary inlet duct is formed to be larger than that of the main inlet duct.

5. The air quality monitoring device of claim 1, wherein the laser module includes:
A laser source that generates a laser beam;
A lens that changes the shape and direction of the laser beam generated by the laser source; and
A laser capture that confines the laser beam after the laser beam passes through the main inlet duct.

6. The air quality monitoring device of claim 5, wherein the focus depth of the laser beam emitted by the laser module is formed to be equal to or greater than the width of the main inlet duct.

7. The air quality monitoring device of claim 5, wherein the laser module further includes a rectangular laser beam shaper that changes the cross-sectional shape of the circular laser beam generated by the laser source into a rectangle.

8. The air quality monitoring device of claim 1, wherein the casing further includes an outlet duct formed at the bottom to allow air that has passed through the main inlet duct to be discharged and a direction-changing duct that connects the top of the main inlet duct and the top of the outlet duct to change the direction of airflow.

9. The air quality monitoring device of claim 8, wherein the inlet and the outlet are placed at the same height.

10. The air quality monitoring device of claim 8, further includes an air ventilation device provided inside the casing, which creates negative pressure to allow air to flow from the inlet to the outlet.

11. The air quality monitoring device of claim 3, wherein the cross-sectional area of the common inlet duct is formed to be larger than the sum of the cross-sectional areas of the main inlet duct and the secondary inlet duct to ensure that the speed of dust particles in the main inlet duct is above a predetermined minimum speed.
